(19) United States
(12) Patent Application Publication
(10) Pub. No.: US 2006/0270441 A1
(43) Pub. Date: Nov. 30, 2006

(54) Mobile communication terminal

(75) Inventor: Katsuya Miyata, Yokohama (JP)

Correspondence Address: COHEN, PONTANI, LIEBERMAN & PAVANE, 551 FIFTH AVENUE, SUITE 1210, NEW YORK, NY, 10176, US

(73) Assignee: Casion Hitachi Mobile Communications Co., Ltd., Higashiyamato-shi (JP)

(21) Appl. No.: 11/441,421

(22) Filed: May 25, 2006

(30) Foreign Application Priority Data
May 25, 2005 (JP) 2005-152512

(51) Int. Cl. H04B 7/00

(52) U.S. Cl. 455/522

(57) ABSTRACT

A mobile communication terminal performs an antenna picture display according to the received signal power measured by a received signal measurement means and the base station transmission conditions acquired by a base station transmission condition acquisition means. Therefore, the display of a large number of antenna pictures regardless of a high error rate at the receiving-end does not occur and the user does not become confused. As a result, the antenna picture display method when using multicast services is improved and user-friendliness is enhanced.

### CROSS-REFERENCE TO RELATED APPLICATION

This application is based upon and claims the benefit of priority from the prior Japanese Patent Application No. 2005-152512, filed May 25, 2005, the entire contents of which is incorporated herein by reference.

### BACKGROUND OF THE INVENTION

1. Field of the Invention

The present invention relates to a mobile communication terminal which improves antenna picture display method and enhances user-friendliness when using multicast service.

2. Description of the Related Art

In many cellular phones, the received signal power is measured regardless of whether the phone is in an idle state or in a communication state and the antenna picture display is changed according to this result. This antenna picture display shows the user an indication of the communication quality at the current time and in the current location. RSSI (Received Signal Strength Indicator), pilot Ec/Io (pilot signal energy-to-total energy ratio), C/I (carrier-to-interference energy ratio), etc. are used as the received signal power which is the basis of the antenna picture display. In addition, the methods proposed in Japanese Patent Laid-Open Publication 2002-374575, etc. are also known.

On the other hand, in recent years, services for delivering video and audio contents, etc. to a plurality of users in broadcasts via a wired broadband circuit such as ADSL (Asymmetric Digital Subscriber Line) and FTTH (Fiber-To-The-Home) are becoming popular. IP multicast technology, represented by IGMP (Internet Group Management Protocol), is used in multicast services such as this.

Multicast services are not limited to wired communication and have spread to the field of wireless communication as well. Specific methods for providing multicast services to cellular phones are disclosed in, for example, Document “3GPP2 Specification C. S0005-Rev. D”, Document “3GPP2 Specification C. S0054 and Japanese Patent Laid-Open Publications 2002-374575, 2001-308856, etc. Each sector has a forward traffic channel provided for multicast services and all mobile devices using the services monitor this same channel. A wireless base station transmits data on the traffic channel for multicast services according to predetermined transmission conditions (modulation method, encoding method, etc). In addition, information on the content ID being delivered, transmission conditions, etc. are also transmitted.

In multicast services, the packet error rate and frame error rate at the receiving-end differ even when the reception electric wave environment measured at the terminal on the receiving-end is the same, for example, when the wireless base station has a high transmission efficiency rate (high transmission rate) but uses a modulation method or encoding method with low error tolerance, or on the contrary, when it has a low transmission efficiency rate (low transmission rate) but uses a modulation method or encoding method with high error tolerance.

Therefore, if the transmission condition of the wireless base station is high in error tolerance, the error rate at the receiving-end becomes low even when the received signal power is poor. On the other hand, if the transmission condition of the wireless base station is low in error tolerance, the error rate at the receiving-end becomes high even when the received signal power is not very poor. In this case, a problem occurs in that because a larger number of antenna pictures (antenna bars) are shown in the latter than in the former in the conventional antenna picture display method, the user perceives that the latter has a higher reception error rate and becomes confused with such an antenna picture display.

### SUMMARY OF THE INVENTION

In accordance with an aspect of the present invention, there is provided a mobile communication terminal comprises a received signal measurement means for measuring received signal power, a base station transmission condition acquisition means for acquiring the transmission conditions of a base station, and a display means for performing antenna picture display according to the received signal power measured by the received signal measurement means and the base station transmission conditions acquired by the base station transmission condition acquisition means.

### BRIEF DESCRIPTION OF THE DRAWINGS

FIG. 1 is a block diagram showing a configuration of a mobile communication terminal according to an embodiment of the present invention;

FIG. 2 is a flowchart showing an operation of an antenna picture display update processing;

FIG. 3 is a diagram showing a data structure of the base station transmission conditions stored in memory section 103;

FIG. 4 is a diagram showing a configuration of a conversion table which generates the number of antenna pictures from the base station transmission conditions; and

FIG. 5A and FIG. 5B are diagrams showing an example of a screen displaying the antenna picture.

### DETAILED DESCRIPTION OF THE PREFERRED EMBODIMENTS

The present invention will hereinafter be described in detail with reference to the preferred embodiments shown in the accompanying drawings.

A. Configuration

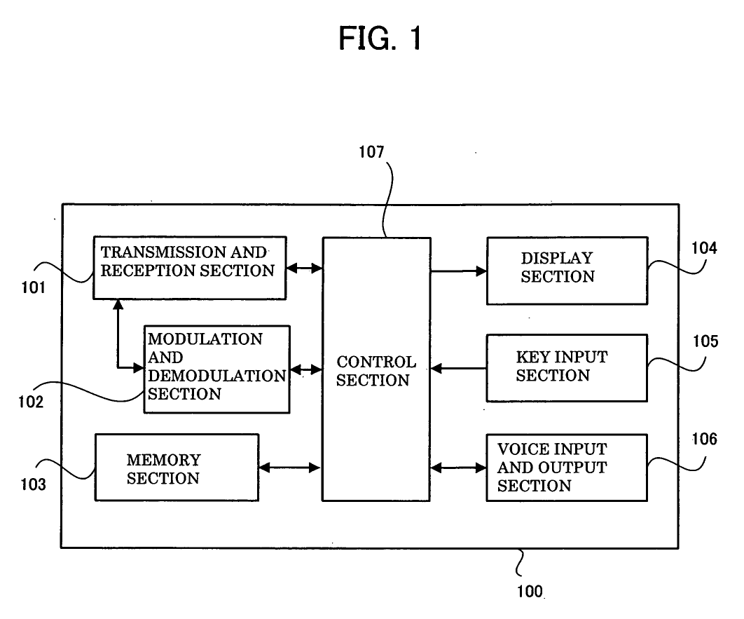

FIG. 1 is a configuration diagram of a mobile communication terminal 100 according to an embodiment of the present invention. The mobile communication terminal 100 shown in this diagram comprises a transmission and reception section 101, a modulation and demodulation section 102, a memory section 103, a display section 104, a key input section 105, a voice input and output section 106 and a control section 107.

The transmission and reception section 101 performs the transmission and reception of wireless signals. In addition, this section is also equipped with a function for measuring the signal strength indicator RSSI, pilot Ec/Io, C/I, etc. of a signal received from a wireless base station (not shown).

Here, RSSI is the received signal strength indicator, pilot Ec/Io is the pilot signal energy-to-total energy ratio, and C/I is the carrier-to-interference energy ratio.

The modulation and demodulation section 102 performs the modulation and demodulation of the transmitted and received data. The memory section 103 stores programs, audio, video, mail, internet, and other user data. The programs stored in the memory section 103 include an antenna picture display update processing (described hereafter) which is executed by the control section 107. The memory section 103 can be either a memory built into the mobile communication terminal 100 or an external memory, such as a removable memory card.

The display section 104 is a display screen, such as a liquid crystal display, which displays mail, internet, basic operation screens, etc. In addition, a plurality of display screens, such as a main screen and a sub screen, can be provided. The key input section 105 receives input from a user by a numeric keypad, function keys, a touch panel, voice input, etc. The voice input and output section 106 comprises a voice input section, such as a microphone, for converting input voice to signals and a voice output section, such as a speaker, for outputting voice.

The control section 107 controls each section, namely the transmission and reception section 101, the modulation and demodulation section 102, the memory section 103, the display section 104, the key input section 105, the voice input and output section 106, etc. Specifically, for example, if the user performs a voice communication operation via the key input section 105, the control section 107 controls the transmission and reception section 101 based on a communication circuit establishment processing program for voice communication stored in the memory section 103 and establishes a communication circuit. When the communication circuit is established, this fact is displayed in the display section 104, and the voice signal input from the voice input and output section 106 is modulated by the modulation and demodulation section 102 and transmitted to the intended party via the transmission and reception section 101. At the same time, the voice data received via the transmission and reception section 101 is demodulated by the modulation and demodulation section 102 and output from the voice input and output section 106 as voice signals.

The mobile communication terminal 100 configured as such accommodates multicast services, receives multicast service notification information transmitted from the base station and acquires information required to use multicast services. The acquired information is stored in the memory section 103. In addition, multicast contents are received by monitoring the channel according to the multicast channel transmission conditions of which notification was given by the multicast service notification information. Furthermore, control information, such as delivery start requests and delivery termination notifications of multicast contents, are transmitted to the base station.

B. Operation

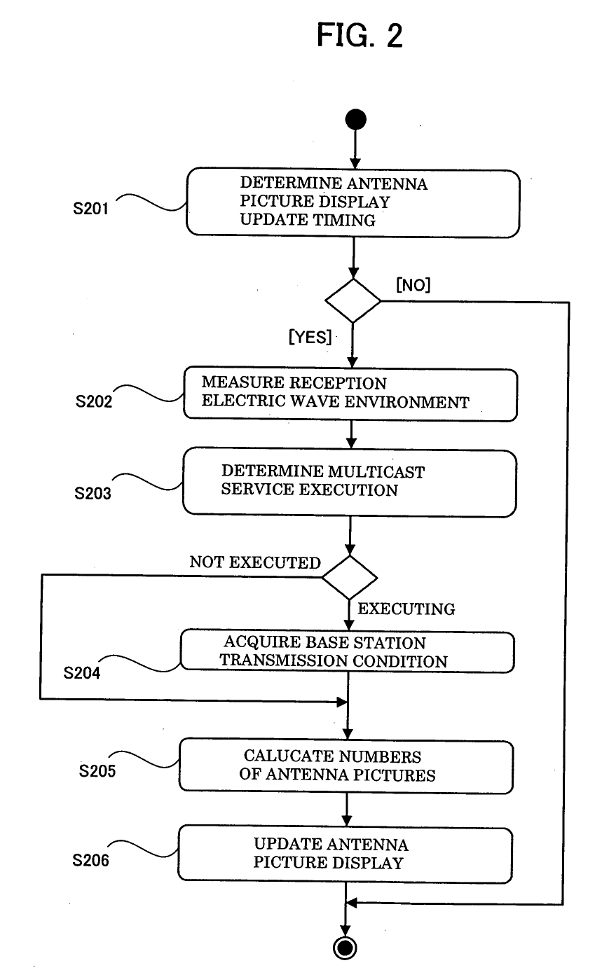

Next, an operation related to antenna picture display in the mobile communication terminal 100 according to the configuration above is described with reference to FIG. 2 through FIG. 5. FIG. 2 is a flowchart showing an operation of an antenna picture display update processing performed by the mobile communication terminal 100.

In the mobile communication terminal 100, an antenna picture display update processing is performed at a predetermined time interval. The update interval can be the same consistently or can differ when in an idle state and when in a communication state. In addition, an update can be performed when the user manipulates the key input section 105, etc. Furthermore, an update can be performed when communication starts or when the use of multicast services commences. There is also a method wherein update processing is not executed when the display section 104 is not performing display.

In any case, when judged that it is time to update the antenna picture display (S201), the control section 107 measures the received signal power (S202). RSSI (Received Signal Strength Indicator), pilot Ec/Io (ratio of pilot signal energy to total energy), and C/I (carrier to interference energy ratio) are specific examples of the received signal power stated herein.

Next, judgment of whether the multicast service is in use made (S203). As a specific example of this judgment processing, a status variable is provided such that “multicast reception state” is set when starting a multicast service and “multicast non-reception state” is set when the multicast service is completed and this variable is referenced. If a multicast service is not in use, an antenna picture number calculation processing is performed (S205). The details of S205 are described hereafter.

If a multicast service is being used, a base station transmission condition acquisition processing (S204) is performed. The base station transmission conditions acquisition are included in the multicast service notification information transmitted by the base station and are stored in the memory section 103 when the multicast service notification information is received. In S204, the information stored in advance in the memory section 103 can be read out.

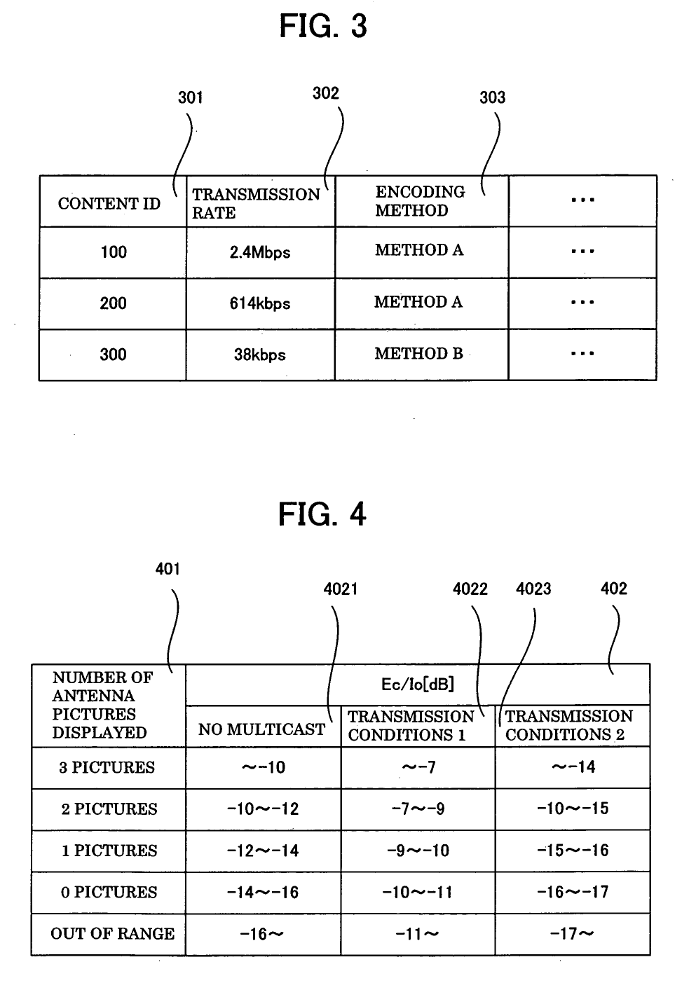

Here, an example of the base station transmission conditions stored in the memory section 103 is described with reference to FIG. 3. Because the base station transmission conditions can be changed for each content delivered by the multicast service, a content ID for identifying the content is included. In addition, information on the transmission rate 302, encoding method 303, etc. are coordinated for each content.

In the example illustrated in FIG. 3, it is shown that the content of content ID=100 is transmitted at a transmission rate of 2.4 Mbps by using encoding method A. More specifically, the transmission rate here is determined from the modulation method, encoding method, the repetition frequency of valid data, etc. and these parameters can be stored as base station transmission conditions in place of the transmission rate. This is merely an example and the information included in the base station transmission conditions is not limited to the foregoing, information.

After the base station transmission condition acquisition processing (S204) for reading out such base station transmission conditions from the memory section 103 is completed, an antenna picture number calculation processing is performed (S205). In S205, the number of antenna pictures is calculated from the received signal power measured in S202 and the base station transmission conditions acquired in S204.

As a specific calculation method, a method using the conversion table shown in FIG. 4 can be considered. In the conversion table shown in this diagram, the number of antenna pictures displayed 401 corresponds with the received signal power 402 (here, Ec/Io [dB] as an example). In addition, the corresponding received signal power includes value 4021 of when the multicast service is not in use, value 4022 of when the multicast content delivered under the transmission conditions 1 is received, and value 4023 of when the multicast content delivered under the transmission conditions 2 is received.

Transmission conditions 1 are conditions wherein the transmission rate is high but error tolerance is low, and transmission conditions 2 are conditions wherein the transmission rate is low but error tolerance is high. Although the conditions are divided into three conditions herein, it can be divided even further. It is assumed that the Ec/Io measured in S202 is −9.5 dB when a conversion table such as this is used. Although the number of antenna pictures to be displayed is three when in an idle state or in a communication state when the multicast service is not in use or when receiving contents transmitted under transmission conditions 2 wherein the error tolerance is high, it is one when receiving contents transmitted under transmission conditions 1 wherein the error tolerance is low.

This is because the reception error rate is higher during reception under transmission conditions 1 compared to normal reception and the user perceives that the communication quality is poor. In addition, if the Ec/Io measured in S202 is −13.5 dB, the number of antenna pictures to be displayed when in an idle state or in a communication state when multicast service is not in use is one and becomes an out-of-range display when receiving content transmitted under transmission conditions 1 wherein the error tolerance is low but becomes three when receiving content transmitted under transmission conditions 2 wherein the error tolerance is high.

This is because the reception error rate becomes low during reception under transmission conditions 2 compared to normal reception and the user perceives that the communication quality is favorable. Although Ec/Io is used as the received signal power above, it is not limited thereto and can be RSSI, C/I or combinations thereof. In addition, instantaneous values can be used respectively and the mean value at a predetermined time can be used as well. Furthermore, although the displayed antenna picture number is calculated herein from the received signal power by comparison with a simple threshold, a hysteresis method can be implemented as well.

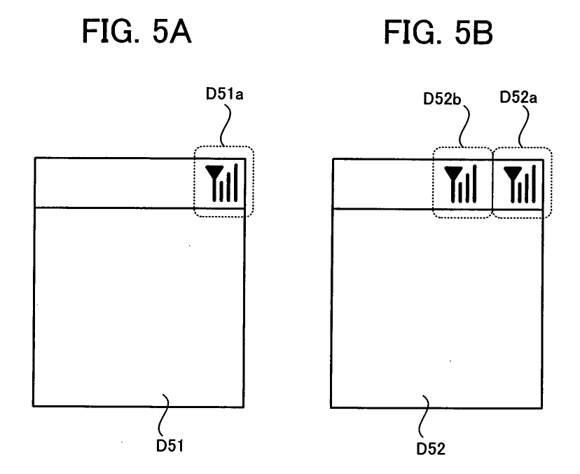

When the processing in S205 is completed as described above, a display processing of the number of antenna pictures calculated in S205 is performed(S206). An antenna picture display example is shown in FIG. 5A and FIG. 5B. In these figures, D51 is a display screen of the mobile communication terminal and D51a is the antenna picture. Although it is stated above that the same antenna picture display is performed when multicast service is in use and at other times, a method for performing multicast service antenna picture display in addition to normal antenna picture display can be considered. A screen display example in this case is D52. D52a is a normal antenna picture and D52b is a multicast service antenna picture. In this case, the normal antenna picture is displayed in correspondence to the received signal power as in conventional terminals and the multicast service antenna picture is displayed according to the calculation result from S205.

When the multicast service is not being used, D52b does not have to be displayed or a display indicating that the multicast service is not in use can be made as well.

As described above, when the base station transmits content under transmission conditions with low error tolerance and the reception error becomes high at the reception terminal during multicast services in the present embodiment, an antenna picture display which does not cause confusion can be actualized.

While the present invention has been described with reference to the preferred embodiments, it is intended that the invention be not limited by any of the details of the description therein but includes all the embodiments which fall within the scope of the appended claims.

What is claimed is:

1. A mobile communication terminal comprising:
a received signal measurement means for measuring received signal power;
a base station transmission condition acquisition means for acquiring the transmission conditions of a base station; and
a display means for performing antenna picture display according to the received signal power measured by the received signal measurement means and the base station transmission conditions acquired by the base station transmission condition acquisition means.

2. The mobile communication terminal according to claim 1, wherein said received signal power measured by said received signal measurement means includes at least RSSI (Received Signal Strength Indicator).

3. The mobile communication terminal according to claim 1, wherein the said received signal power measured by said received signal measurement means includes at least Ec/Io (pilot signal energy-to-total energy ratio).

4. The mobile communication terminal according to claim 1, wherein said received signal power measured by said received signal measurement means includes at least C/I (carrier-to-interference energy ratio).

5. The mobile communication terminal according to claim 1, wherein said base station transmission conditions acquired by said base station transmission condition acquisition means include at least a transmission rate.

6. The mobile communication terminal according to claim 1, wherein said base station transmission conditions acquired by the base station transmission condition acquisition means include at least a modulation method.

7. The mobile communication terminal according to claim 1, wherein said base station transmission conditions acquired by the base station transmission condition acquisition means include at least an encoding method.
